(19) United States
(12) Patent Application Publication
(10) Pub. No.: US 2023/0111514 A1
(43) Pub. Date: Apr. 13, 2023

(54) Screw

(71) Applicant: Günter Weippert, Öhringen (DE)

(72) Inventor: Günter Weippert, Öhringen (DE)

(21) Appl. No.: 17/907,993

(22) PCT Filed: Mar. 2, 2021
(86) PCT No.: PCT/DE2021/100213

§ 371 Date: Aug. 30, 2022

(30) Foreign Application Priority Data
Mar. 6, 2020 (DE) 10 2020 106 119.6

(51) Int. Cl. F16B 25/00

(52) U.S. Cl. CPC F16B 25/0047

(57) ABSTRACT

A screw (1) is proposed, which has a shank (4) having a longitudinal axis (12), which has a first end (9) and a second end (17), the shank (4) having at least one thread (5) at least to some extent, the thread (5) having a thread groove (6), which has a thread ridge (7), a thread valley (8), a thread depth resulting from the thread ridge (7) and the thread valley (8), a flank (10) facing the first end (9) of the shank (2) and a flank (11) facing away from the first end (9) of the shank (2), a flank (10), from the thread valley to the thread ridge (7), facing the first end (9) of the shank (2) having at least two different angles enclosed between the longitudinal axis (12) and the flank (10) and/or a flank (11), from the thread valley (8) to the thread ridge (7), facing away from the first end (9) of the shank (2) having at least two different angles enclosed between the longitudinal axis (12) and the flank (11), the angle (20) enclosed in the thread valley (8) of a flank (10) facing the first end (9) of the shank (2) being shallower than the angle (21) enclosed at the thread ridge (7), and/or the angle (22) enclosed in the thread valley (8) of a flank (11) facing away from the first end (9) of the shank (2) being shallower than the angle (23) enclosed at the thread ridge (7), as a result of which, easy screwing of the screw (1) according to the invention into a mating part becomes possible and self-locking prevents loosening of the screw (1) according to the invention.

### CROSS REFERENCE TO RELATED APPLICATIONS

This application is the U.S. national stage of International Application No. PCT/DE2021/100213, filed on Mar. 2, 2021. The international application claims the priority of DE 102020106119.6 filed on Mar. 6, 2020; all applications are incorporated by reference herein in their entirety.

### BACKGROUND

The invention is based on a screw according to the generic type of claim 1.

Screws, which generally have a cylindrical or slightly conical body and the surface of which has at least one thread, have already been part of the prior art in a wide range of designs for a long time. Thus, there are in particular metal screws, of which the shank and the contour of the thread are of cylindrical design, in order to screw them into a matching mating thread, wood screws, the shank part of which, which is provided with a thread, ends in a point, wherein the thread flanks thereof are sharper than those of metal screws, as a result of which the thread in the mating part is cut in by means of the screw itself during the mounting, and chipboard screws, which, with a cylindrical contour and sharp flanks, are suitable for screwing in particular into chipboard, plasterboard or wall plugs.

The different screws, which can be of different lengths, for the most part consist of metal, alloys, such as brass or other non-ferrous metal alloys, non-ferrous metals, such as copper, aluminium or titanium, wood, fibre-reinforced composite material or plastic. Often, screws have a screw head, wherein a multiplicity of screw head shapes results due to the design of the edge of the screw head, which can in particular be round, polygonal (e.g. square, hexagonal) or ribbed, the top side of the screw head, which can in particular be flat, flat-rounded, spherical (at most hemispheric) or conical, the underside of the screw head, which can in particular be flat or conical (countersunk head), the head thickness of the screw head and the outer diameter of the screw head. In addition, the screw head generally also has a head drive for placing a screwdriver or a spanner. Known profiles of head drives are the slotted head, cross head, external hexagon, external square, internal hexagon, internal hexalobe e.g. with five or six lobes, internal triple square or internal square.

The flanks of the screw thread form with the mating thread a positive connection acting perpendicularly to the flanks. By screwing in the screw, a force N is created acting in the normal direction between the mutually facing flank surfaces, and as a consequence of the friction between the two, an adhesion counter to the rotation is created. However, the disadvantage is that often the existing adhesion counter to unscrewing is insufficient, as a result of which the connection loosens again.

In order to overcome this disadvantage, screws are already known from the Chinese patent CN 102 278 348 B, from the European patent applications EP 0 104 552 A1 and EP 0 713 017 A2, the U.S. Pat. No. 6,565,302 B2, the German patent DE 10 2004 011 668 B3 and the German laid open specification DE 40 16 724 A1, which screws are characterized by a particular design of the thread. In spite of this, the existing adhesion counter to unscrewing is often still not sufficient, as a result of which the connection loosens again.

The object of the invention is therefore to provide a screw, by means of which the disadvantages of the prior art are overcome.

### SUMMARY

A screw (1) is proposed, which has a shank (4) having a longitudinal axis (12), which has a first end (9) and a second end (17), the shank (4) having at least one thread (5) at least to some extent, the thread (5) having a thread groove (6), which has a thread ridge (7), a thread valley (8), a thread depth resulting from the thread ridge (7) and the thread valley (8), a flank (10) facing the first end (9) of the shank (4) and a flank (11) facing away from the first end (9) of the shank (4), a flank (10), from the thread valley to the thread ridge (7), facing the first end (9) of the shank (4) having two different angles enclosed between the longitudinal axis (12) and the flank (10) and a flank (11), from the thread valley (8) to the thread ridge (7), facing away from the first end (9) of the shank (4) having two different angles enclosed between the longitudinal axis (12) and the flank (11), the angle (20) enclosed in the thread valley (8) of a flank (10) facing the first end (9) of the shank (4) being shallower than the angle (21) enclosed at the thread ridge (7), and the angle (22) enclosed in the thread valley (8) of a flank (11) facing away from the first end (9) of the shank (4) being shallower than the angle (23) enclosed at the thread ridge (7), the thread ridge (7) having at least one peak and at least one angle (21, 23) enclosed at the thread ridge being a right angle, as a result of which, easy screwing of the screw (1) according to the invention into a mating part becomes possible and self-locking prevents loosening of the screw (1) according to the invention.

### DETAILED DESCRIPTION

The screw according to the invention, having the features of claim 1, which has a shank having a longitudinal axis, which has a first end and a second end, the shank having at least one thread at least to some extent, the thread having a thread groove, which has a thread ridge, a thread valley, a thread depth resulting from the thread ridge and the thread valley, a flank facing the first end of the shank and a flank facing away from the first end of the shank, a flank, from the thread valley to the thread ridge, facing the first end of the shank having two different angles enclosed between the longitudinal axis and the flank (internal angles) and a flank, from the thread valley to the thread ridge, facing away from the first end of the shank having two different angles enclosed between the longitudinal axis and the flank (internal angles), the angle enclosed in the thread valley of a flank facing the first end of the shank being shallower than the angle enclosed at the thread ridge and the angle enclosed in the thread valley of a flank facing away from the first end of the shank being shallower than the angle enclosed at the thread ridge, the thread ridge having at least one peak and at least one angle enclosed at the thread ridge being a right angle, by contrast has the advantage that easy screwing of the screw according to the invention into a mating part becomes possible and self-locking prevents loosening of the screw according to the invention. Due to the at least two different enclosed angles, better adhesion is effected, as a result of which the connection becomes more stable due to the optimized distribution of stresses in particular.

According to an advantageous embodiment of the screw according to the invention, the enclosed angle of a flank is at most 60° in the thread valley and at least 61° at the thread ridge.

According to an additional advantageous embodiment of the screw according to the invention, the first end of the shank has a head (screw head).

According to a related advantageous embodiment of the screw according to the invention, the head has a head drive.

According to an additional advantageous embodiment of the screw according to the invention, the head has a collar.

According to an additional advantageous embodiment of the screw according to the invention, the second end of the shank has a point, a centring bevel or a dog point.

According to an additional advantageous embodiment of the screw according to the invention, at least one thread has a lead of between 1.0 mm and 4.0 mm, preferably between 1.5 mm and 2.5 mm.

According to an additional advantageous embodiment of the screw according to the invention, the flank facing the first end of the shank has a surface on the thread ridge, which transitions at a transition into a surface arranged on the valley side, and/or the flank facing away from the first end of the shank has a surface on the thread ridge, which transitions at a transition into a surface arranged on the valley side.

According to a related advantageous embodiment of the screw according to the invention, the transition on the flank facing the first end of the shank is arranged at a height which is at most two thirds of a thread height resulting from the thread valley and the thread ridge, and/or the transition on the flank facing away from the first end of the shank is arranged at a height which is at most two thirds of a thread height resulting from the thread valley and the thread ridge.

According to a related advantageous embodiment of the screw according to the invention, the transition on the flank facing the first end of the shank is arranged higher than the transition on the flank facing away from the first end of the shank. It is however also conceivable that the transition on the flank facing the first end of the shank is arranged at the same height as the transition on the flank facing away from the first end of the shank.

According to a related advantageous embodiment of the screw according to the invention, the screw is made from plastic.

According to an additional advantageous embodiment of the screw according to the invention, the screw is a self-cutting screw and/or a self-tapping screw. This has the advantage that a thread does not have to be arranged on the mating part, which is made from plastic for example, as a result of which the production costs are reduced, as either no opening at all or, if necessary, only an opening has to be prepared. Therefore, there is a cost saving in terms of the production costs and the tool cost reduction, as the work step of forming a thread in the mating part is dispensed with.

Further advantages and advantageous embodiments of the invention can be drawn from the following description, the drawing and the claims.

### BRIEF DESCRIPTION OF THE DRAWINGS

Preferred exemplary embodiments of the subject according to the invention are illustrated in the drawings and are explained in more detail in the following. In the figures

FIG. 1 shows a side view of a screw corresponding to the prior art,

FIG. 2 shows a sectional view of the screw along the line A-A from FIG. 1,

FIG. 3 shows a detail B of the screw from FIG. 2,

FIG. 4 shows a plan view of a screw head of the screw according to FIG. 1,

FIG. 5 shows a perspective view of a further screw corresponding to the prior art,

FIG. 6 shows a side view of the screw according to FIG. 5,

FIG. 7 shows a sectional view of the screw along the line A-A from FIG. 6,

FIG. 8 shows a detail B of the screw from FIG. 6,

FIG. 9 shows a plan view of a screw head of the screw according to FIG. 5,

FIG. 10 shows a perspective view of a further screw corresponding to the prior art,

FIG. 11 shows a side view of the screw according to FIG. 10,

FIG. 12 shows a sectional view of the screw along the line A-A from FIG. 11,

FIG. 13 shows a detail B of the screw from FIG. 12,

FIG. 14 shows a plan view of a screw head of the screw according to FIG. 10,

FIG. 15 shows a side view of a further screw corresponding to the prior art,

FIG. 16 shows a sketch of an exemplary embodiment of a tooth flank profile corresponding to the prior art,

FIG. 17 shows a sketch of the exemplary embodiment of a tooth flank profile according to FIG. 16,

FIG. 18 shows a sketch of a further exemplary embodiment of a tooth flank profile corresponding to the prior art,

FIG. 19 shows a sketch of an exemplary embodiment according to the invention of a tooth flank profile, and

FIG. 20 shows a sketch of the exemplary embodiment according to the invention of a tooth flank profile according to FIG. 19.

### DETAILED DESCRIPTION OF THE PREFERRED EMBODIMENTS

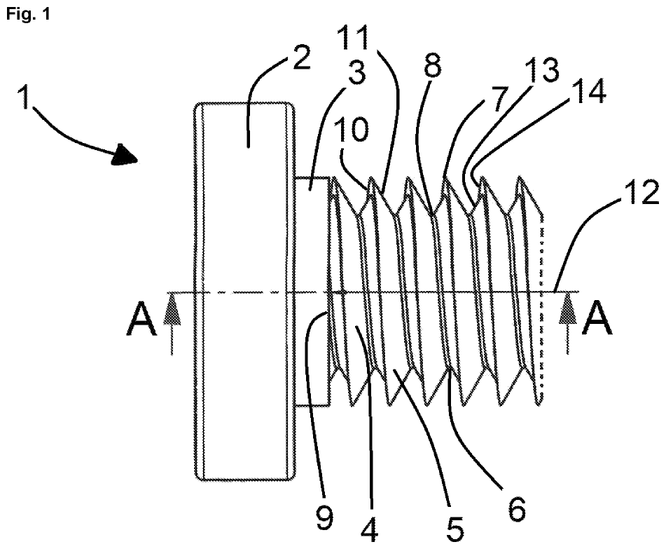

FIG. 1 shows a side view of a screw 1 corresponding to the prior art. The screw 1 has a screw head 2 (head), which has a collar 3, and a shank 4, which has a thread 5 and, as indicated by the dashed line, is only partially illustrated. The thread 5 has a thread groove 6, which has a thread ridge 7, a thread valley 8, a thread depth resulting from the thread ridge 7 and the thread valley 8, a flank 10 facing the first end 9 of the shank 4 and a flank 11 facing away from the first end 9 of the shank 4. The screw 1 according to the invention illustrated in FIG. 1, which has a longitudinal axis 12, has a flank 10 facing the first end 9 of the shank 4, which is characterized from the thread valley up to the thread ridge by two different enclosed angles, namely a shallower enclosed angle 13 and a steeper enclosed angle 14.

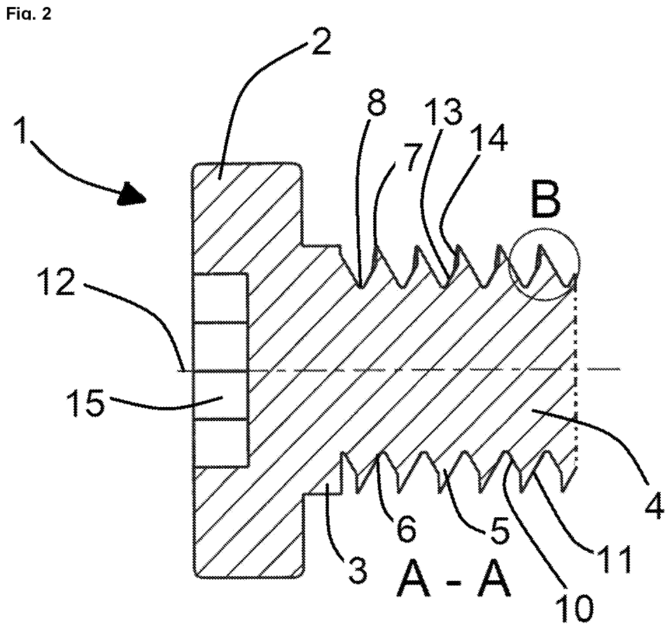

FIG. 2 shows a sectional view of the screw 1 along the line A-A from FIG. 1. The screw head 2 has a head drive 15 for placing a screwdriver. Of course, the screw head 2, if it is present, and/or the collar 3, if it is present, may have different shapes. Bevels are conceivable, as a result of which e.g. a countersunk screw is created.

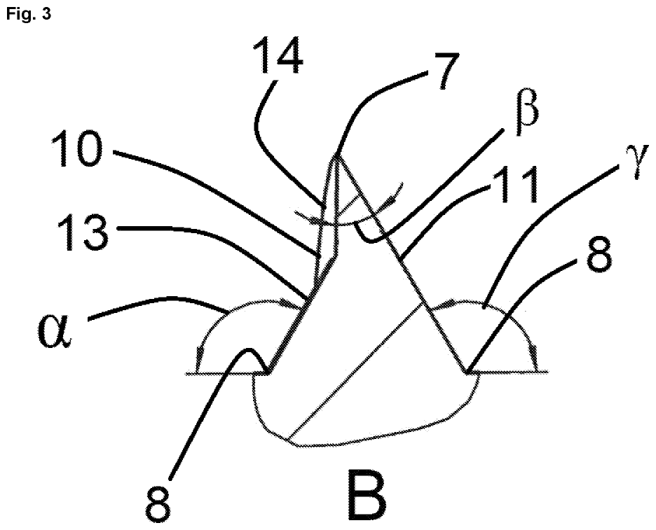

FIG. 3 shows a detail B of the screw 1 from FIG. 2. The angles illustrated with the arrows are to be understood by way of example and can of course be varied. For example, angle α could be 120°, angle β could be 31° and angle Y could be 120°. The angle of a flank 10 facing the first end 9 of the shank 4, in the thread valley 8 and enclosed between the longitudinal axis and the flank 10 would in this example be calculated to be 60° (=180°−angle α). The angle enclosed between the longitudinal axis and the flank 11 would in this example be calculated to be 60° (=180°−angle Y).

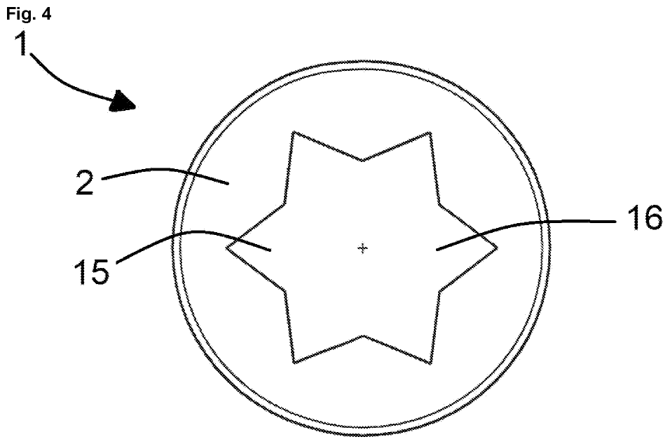

FIG. 4 shows a plan view of a screw head 2 of the screw 1 according to FIG. 1. The head drive 15 is designed by way of example to be an internal hexalobe 16.

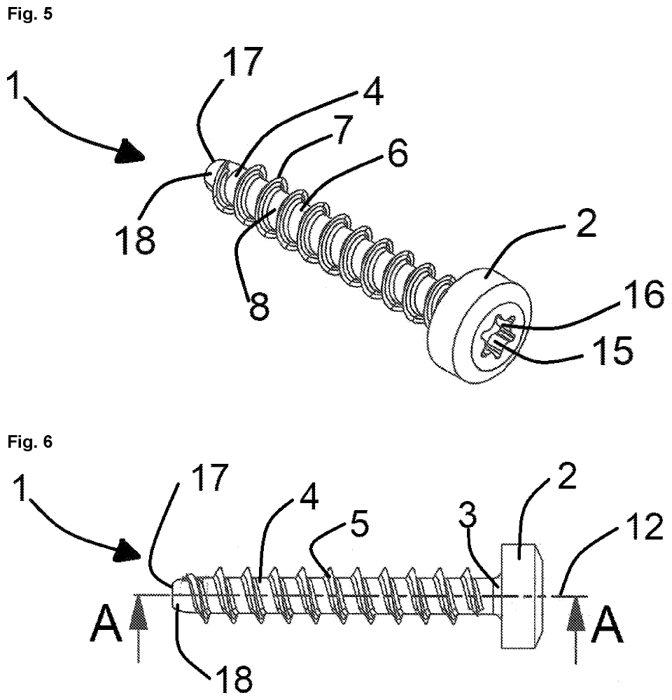

FIG. 5 shows a perspective view of a further screw 1 corresponding to the prior art. The shank 4 has a second end 17 in the form of a centring bevel 18. It would also be conceivable that the second end 17 is designed as a point or dog point.

FIG. 6 shows a side view of the screw 1 according to FIG. 5. The collar 3 is slightly sloping here.

FIG. 7 shows a sectional view of the screw 1 along the line A-A from FIG. 6.

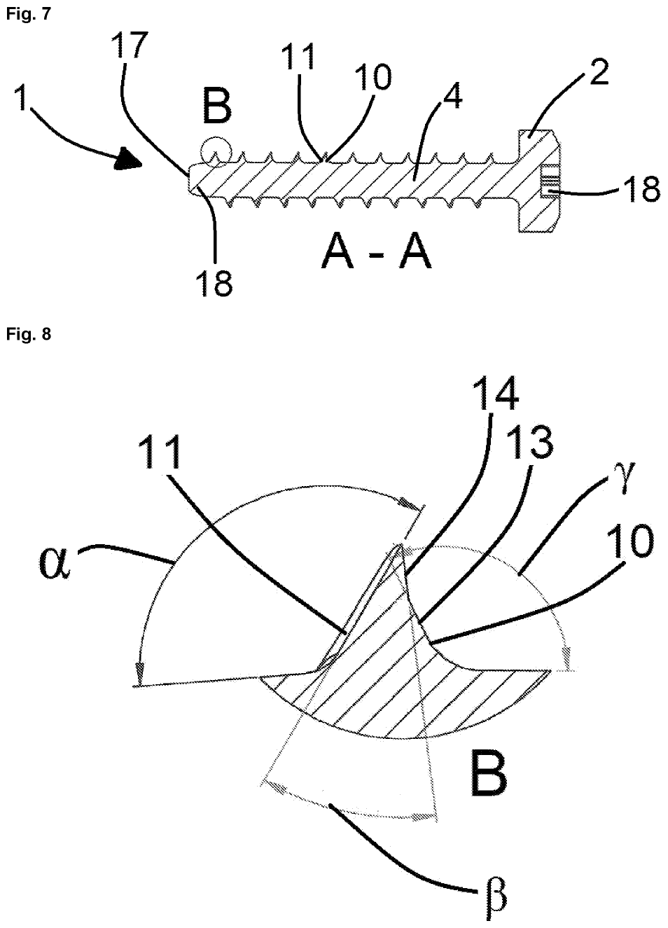

FIG. 8 shows a detail B of the screw 1 from FIG. 6. For example, angle α could be 124°, angle β could be 37° and angle Y could be 115°.

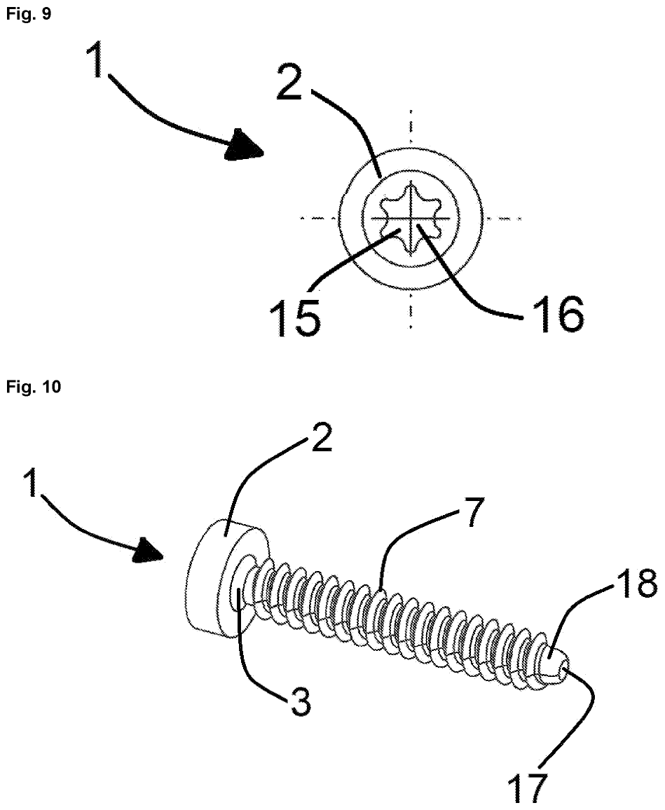

FIG. 9 shows a plan view of a screw head of the screw 1 according to FIG. 5.

FIG. 10 shows a perspective view of a further screw 1 corresponding to the prior art.

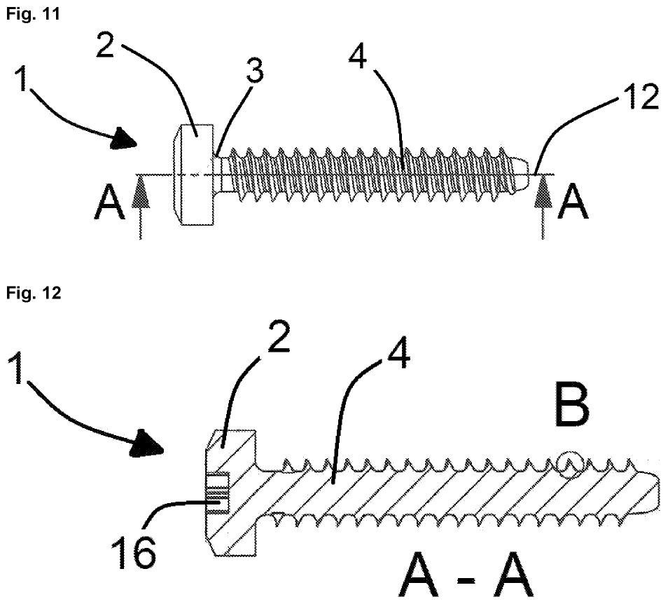

FIG. 11 shows a side view of the screw 1 according to FIG. 10.

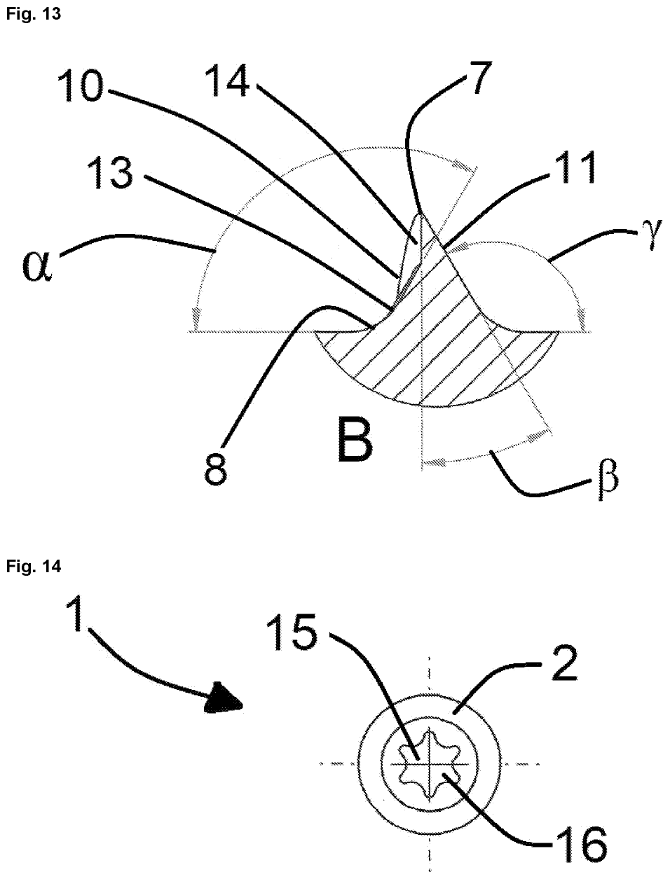

FIG. 12 shows a sectional view of the screw 1 along the line A-A from FIG. 11.

FIG. 13 shows a detail B of the screw 1 from FIG. 12. For example, angle α could be 120°, angle β could be 30° and angle γ could be 120°.

FIG. 14 shows a plan view of a screw head of the screw 1 according to FIG. 10.

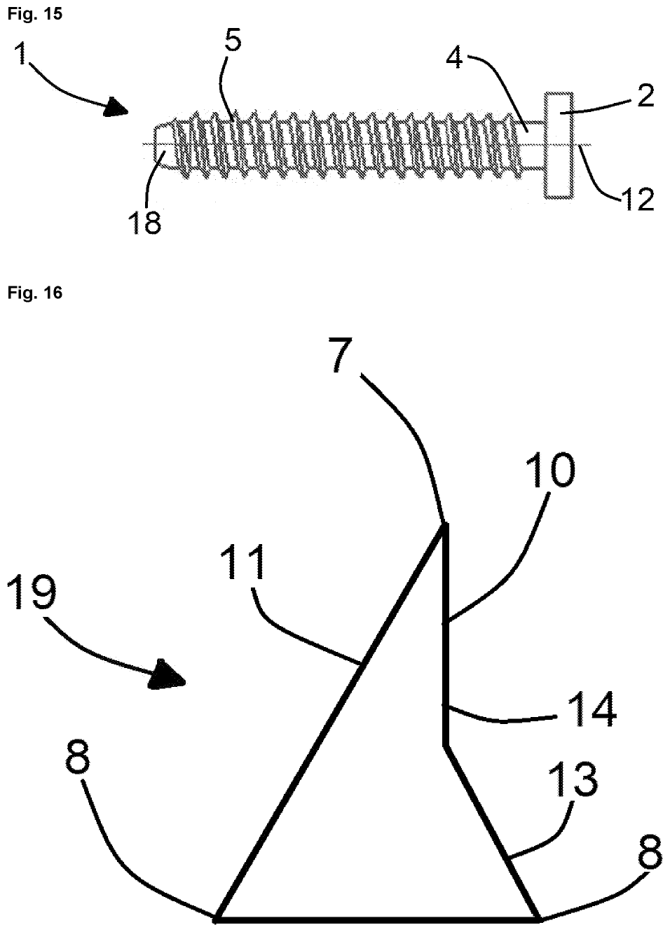

FIG. 15 shows a side view of a further screw 1 corresponding to the prior art.

FIG. 16 shows a sketch of an exemplary embodiment of a tooth flank profile 19 corresponding to the prior art.

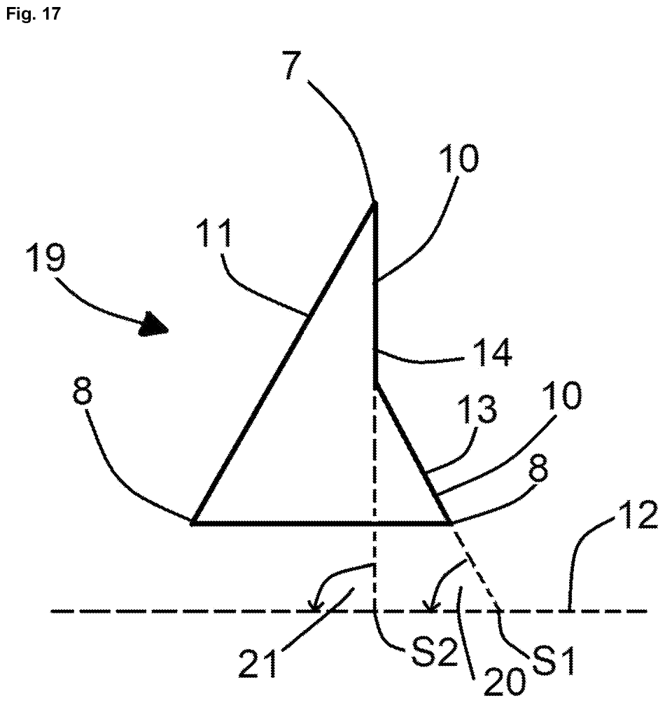

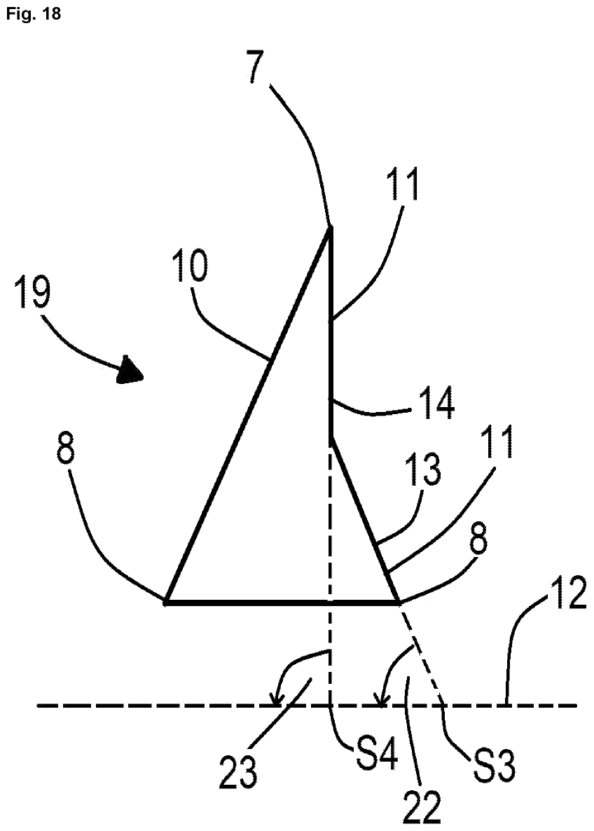

FIG. 17 shows a sketch of the exemplary embodiment of a tooth flank profile 19 according to FIG. 16. In this case, a flank 10 facing the first end of the shank 4 has two different angles enclosed between the longitudinal axis 12 and the flank 10, namely an enclosed angle 20, which results between an imaginary extension of the flank 10 located in the thread valley 8, which intersects the longitudinal axis 12 at the vertex S1, and the longitudinal axis 12, and an enclosed angle 21, which results between an imaginary extension of the flank 10 located on the thread ridge 7, which intersects the longitudinal axis 12 at the vertex S2, and the longitudinal axis 12. According to the invention, the angle 20 is shallower than the angle 21.

FIG. 18 shows a sketch of a further exemplary embodiment of a tooth flank profile 19 corresponding to the prior art. In this case, a flank 11 facing away from the first end of the shank 4 has two different angles enclosed between the longitudinal axis 12 and the flank 11, namely an enclosed angle 22, which results between an imaginary extension of the flank 11 located in the thread valley 8, which intersects the longitudinal axis 12 at the vertex S3, and the longitudinal axis 12, and an enclosed angle 23, which results between an imaginary extension of the flank 11 located on the thread ridge 7, which intersects the longitudinal axis 12 at the vertex S4, and the longitudinal axis 12. According to the invention, the angle 22 is shallower than the angle 23.

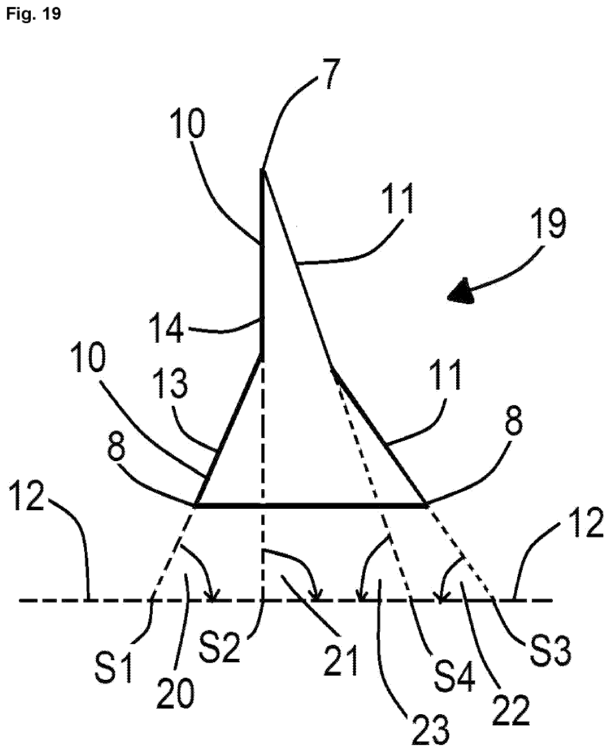

FIG. 19 shows a sketch of an exemplary embodiment of a tooth flank profile 19 according to the invention. In this case, a flank 10 facing the first end of the shank 4 has two different angles enclosed between the longitudinal axis 12 and the flank 10, namely an enclosed angle 20, which results between an imaginary extension of the flank 10 located in the thread valley 8, which intersects the longitudinal axis 12 at the vertex S1, and the longitudinal axis 12, and an enclosed angle 21, which results between an imaginary extension of the flank 10 located on the thread ridge 7, which intersects the longitudinal axis 12 at the vertex S2, and the longitudinal axis 12. According to the invention, the angle 20 is shallower than the angle 21. In addition, a flank 11 facing away from the first end of the shank 4 has two different angles enclosed between the longitudinal axis 12 and the flank 11, namely an enclosed angle 22, which results between an imaginary extension of the flank 11 located in the thread valley 8, which intersects the longitudinal axis 12 at the vertex S3, and the longitudinal axis 12, and an enclosed angle 23, which results between an imaginary extension of the flank 11 located on the thread ridge 7, which intersects the longitudinal axis 12 at the vertex S4, and the longitudinal axis 12. According to the invention, the angle 22 is shallower than the angle 23.

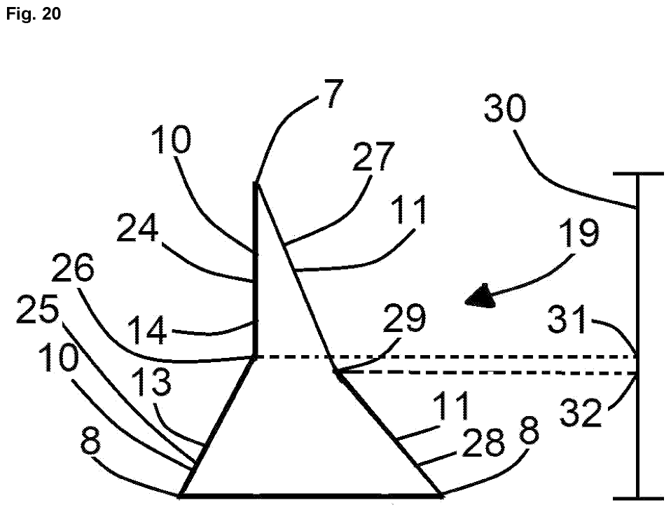

FIG. 20 shows a sketch of the exemplary embodiment of a tooth flank profile 19 according to the invention according to FIG. 19. The flank 10 facing the first end 9 of the shank 4 has a surface 24 on the thread ridge 7, which transitions at a transition 26 into a surface 25 arranged on the valley side. In addition, the flank 11 facing away from the first end 9 of the shank 4 has a surface 27 on the thread ridge 7, which transitions at a transition 29 into a surface 28 arranged on the valley side. A thread height 30 resulting from the thread valley 8 and the thread ridge 7 is sketched in. A height 31 of the transition 26 and a height 32 of the transition 29 are indicated on the thread height 30. In a different design, it would also be conceivable that the height 31 of the transition 26 and the height 32 of the transition 29 are arranged at the same height or that the height 31 of the transition 26 is arranged lower than the height 32 of the transition 29. In a different design, it would also be conceivable that the height 31 of the transition 26 and the height 32 of the transition 29 does not have a constant height in the course of the thread.

The surfaces 24, 25, 27 and 28 can be of different sizes or the same size, depending on the design.

The screw 1 according to the invention can be used in the following fields of use in particular: medical engineering, food industry, electrical engineering, lightweight construction, water and waste water engineering, automation, automotive industry, aerospace engineering, model making and device manufacture.

The screw 1 according to the invention is preferably a screw made from plastic. The use of plastic offers the advantage that a multiplicity of colour variations are possible, as a result of which the screw 1 according to the invention can also be used as a design element. In addition, by contrast with steel screws, a thermal and/or electrical insulation and/or weight saving is possible. Furthermore, plastic screws are corrosion-resistant and have chemical resistance if a suitable plastic is chosen. In addition, plastics which have special properties can be used, as a result of which, e.g. UL listing, food approval and/or drinking water approval is achieved.

All of the features presented in the description, the following claims and the drawings may be important for the invention both individually and in any desired combination with one another.

### LIST OF REFERENCE NUMERALS

1 Screw

2 Screw head

3 Collar

4 Shank

5 Thread

6 Thread groove

7 Thread ridge

8 Thread valley

9 First end

10 Flank

11 Flank

12 Longitudinal axis

13 Shallow enclosed angle

14 Steep enclosed angle

15 Head drive

16 Internal hexalobe

17 Second end

18 Centring bevel

19 Tooth flank profile

20 Angle

21 Angle

22 Angle

23 Angle

24 Surface

25 Surface

26 Transition

27 Surface

28 Surface

29 Transition

30 Thread height

31 Height

32 Height

S1 Vertex

S2 Vertex

S3 Vertex

S4 Vertex

1.-13. (canceled)

14. A screw (1),
having a shank (4) having a longitudinal axis (12), which has a first end (9) and a second end (17), the shank (4) having at least one thread (5) at least to some extent, the thread (5) having a thread groove (6), which has a thread ridge (7), a thread valley (8), a thread depth resulting from the thread ridge (7) and the thread valley (8), a flank (10) facing the first end (9) of the shank (4) and a flank (11) facing away from the first end (9) of the shank (4)
characterized
in that a flank (10), from the thread valley to the thread ridge (7), facing the first end (9) of the shank (4) has two different angles (20, 21) enclosed between the longitudinal axis (12) and the flank (10) and a flank (11), from the thread valley (8) to the thread ridge (7), facing away from the first end (9) of the shank (4) has two different angles (22, 23) enclosed between the longitudinal axis (12) and the flank (11), wherein the angle (20) enclosed in the thread valley (8) of a flank (10) facing the first end (9) of the shank (4) is shallower than the angle (21) enclosed at the thread ridge (7), and the angle (22) enclosed in the thread valley (8) of a flank (11) facing away from the first end (9) of the shank (4) is shallower than the angle (23) enclosed at the thread ridge (7), wherein the thread ridge (7) has at least one peak and at least one angle (21, 23) enclosed at the thread ridge is a right angle.

15. The screw (1) according to claim 14,
characterized
in that the enclosed angle of a flank (10, 11) is at most 60° in the thread valley (8) and at least 61° at the thread ridge (7).

16. The screw (1) according to claim 14,
characterized
in that the first end (9) of the shank (4) has a head.

17. The screw (1) according to claim 16,
characterized
in that the head has a head drive (15).

18. The screw (1) according to claim 16,
characterized
in that the head has a collar (3).

19. The screw (1) according to claim 14,
characterized
in that the second end (17) of the shank (4) has a point, a centring bevel (18) or a dog point.

20. The screw (1) according to claim 14,
characterized
in that at least one thread (5) has a lead of between 1.0 mm and 4.0 mm.

21. The screw (1) according to claim 14,
characterized
in that the flank (10) facing the first end (9) of the shank (4) has a surface (24) on the thread ridge (7), which transitions at a transition (26) into a surface (25) arranged on the valley side, and/or the flank (11) facing away from the first end (9) of the shank (4) has a surface (27) on the thread ridge (7), which transitions at a transition (29) into a surface (28) arranged on the valley side.

22. The screw (1) according to claim 21,
characterized
in that the transition (26) on the flank (10) facing the first end (9) of the shank (4) is arranged at a height (31) which is at most two thirds of a thread height (30) resulting from the thread valley (8) and the thread ridge (7), and/or the transition (29) on the flank (11) facing away from the first end (9) of the shank (4) is arranged at a height (32) which is at most two thirds of a thread height (30) resulting from the thread valley (8) and the thread ridge (7).

23. The screw (1) according to claim 21,
characterized
in that the transition (26) on the flank (10) facing the first end (9) of the shank (4) is arranged higher than the transition (29) on the flank (11) facing away from the first end (9) of the shank (4).

24. The screw (1) according to claim 14,
characterized
in that the screw (1) is made from plastic.

25. The screw (1) according to claim 14,
characterized
in that the screw (1) is a self-cutting screw (1) and/or a self-tapping screw (1).
